(19) United States
(12) Patent Application Publication
(10) Pub. No.: US 2004/0113560 A1
(43) Pub. Date: Jun. 17, 2004

(54) Magnetron

(76) Inventor: Michael Barry Clive Brady, Maldon (GB)

Correspondence Address: VENABLE, BAETJER, HOWARD AND CIVILETTI, LLP, P.O. BOX 34385, WASHINGTON, DC, 20043-9998, US

(21) Appl. No.: 10/467,836

(22) PCT Filed: Feb. 13, 2002
(86) PCT No.: PCT/GB02/00652

(30) Foreign Application Priority Data
Feb. 13, 2001 (GB) 0103530.2

(51) Int. Cl. H01J 25/50

(52) U.S. Cl. 315/39.51; 315/39.75

(57) ABSTRACT

A magnetron comprises an anode (2) having vaner (3a, 3b) which define a plurality of cavities. A dielectric resonator (7) is located such that it is in communication with at least one of the vanes (3a, 3b). In use, the dielectric resonator (7) at least partially absorbs spurious radiation generated in a predetermined mode of operation of the magnetron, such as the π-1 mode. Power generated in the π-1 mode, if transmitted, may interfere with other electronic devices. The resonator (7) may be of ceramics material, such as alumina.

In one known magnetron design, a central cylindrical cathode is surrounded by an anode structure which typically comprises a conductive cylinder supporting a plurality of anode vanes extending inwardly from its interior surface. During operation, a magnetic field is applied in a direction parallel to the longitudinal axis of the cylindrical structure and, in combination, with the electrical field between the cathode and anode, acts on electrons emitted by the cathode, resulting in resonances occurring and the generation of r.f. energy. A magnetron is capable of supporting several modes of oscillation depending on coupling between the cavities defined by the anode vanes, giving variations in the output frequency and power. The mode of operation which is usually required is the so-called a mode of operation.

It is desirable to be able to suppress the transmission of power generated in certain modes, for example, the so-called π-1 mode. It has been found that power generated in this mode, if transmitted, may interfere with other electronic devices such as mobile phones, satellite links and other communication systems. Various methods have been proposed to suppress this mode of operation but these have generally been found to be costly, complicated, and also to suppress radiation in desired modes of operation, for example the π mode. The invention arose from work relating to magnetrons for marine radar applications. Such magnetrons are small, simple and low cost devices and therefore a low cost and straight forward solution to the problem of π-1 radiation was sought.

The invention provides a magnetron comprising an anode having at least one vane defining a plurality of cavities and a dielectric resonator in communication with the at least one vane arranged, in use, to at least partially absorb radiation generated in a predetermined mode of operation of the magnetron

The provision of dielectric material in communication with the vane or vanes results in the absorption of spurious radiation.

Preferably, the predetermined mode is the π-1 mode. The absorption of radiation generated in this mode prevents interference with other electronic devices.

Advantageously the resonator is of ceramics material, preferably alumina. The resonator may be annular and co-axial with the vanes of the anode.

According to a second aspect of the invention, there is provided means for absorbing radiation generated by a magnetron in a predetermined mode of operation, said means comprising a dielectric resonator arranged to be in communication with at least one anode vane of the magnetron.

The invention will now be described, by way of example, with reference to the accompanying drawings, in which:

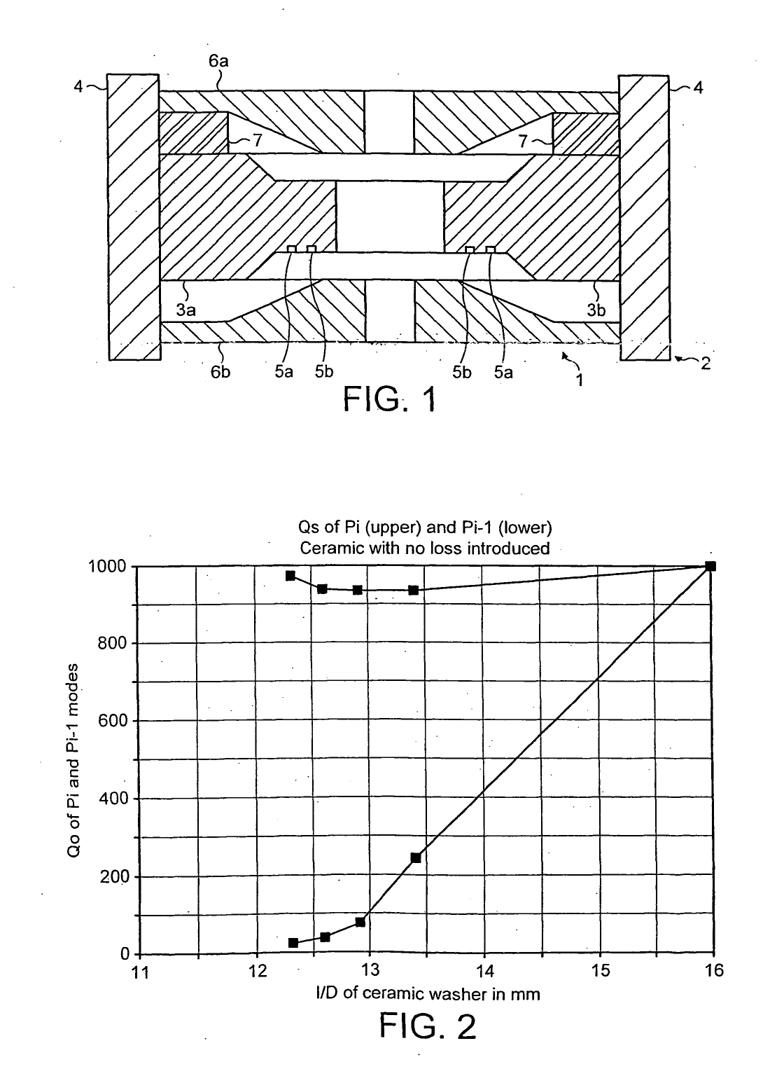

FIG. 1 is a cross-sectional view of a magnetron constructed according to the invention;

FIG. 2 is a graph of experimental data, showing the change in Q of the π and π-1 modes of the magnetron of FIG. 1;

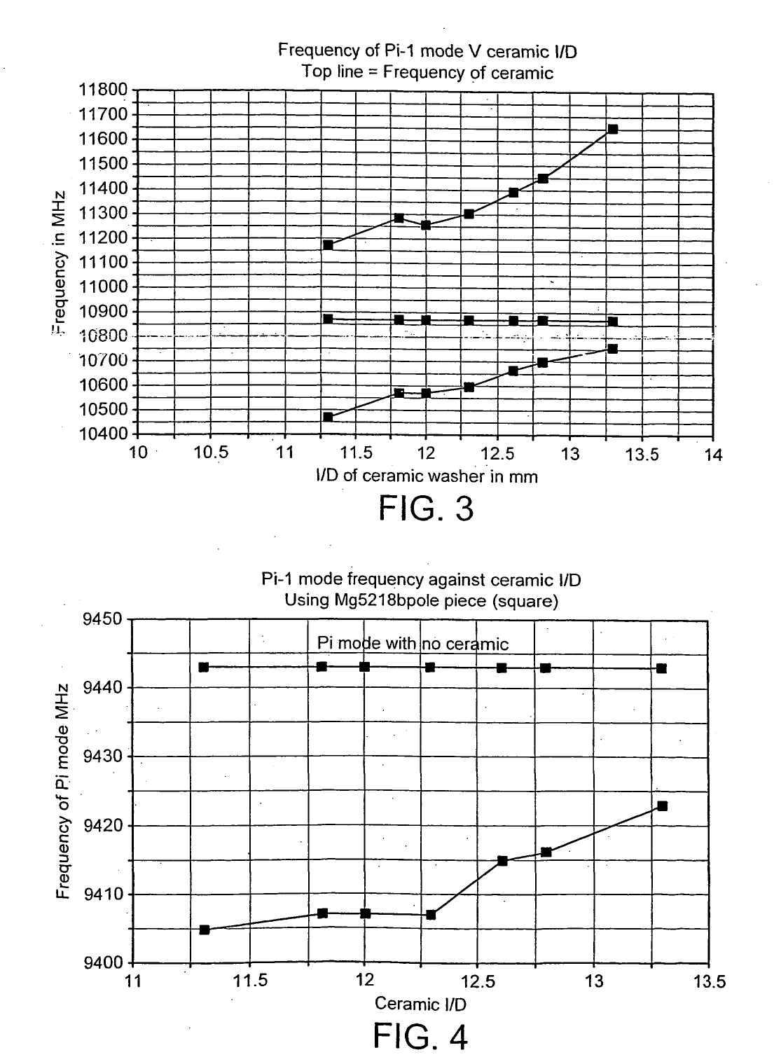

FIG. 3 is a graph of experimental data, showing the change in frequency of the π-1 mode of the magnetron of FIG. 1; and

FIG. 4 is a graph of experimental data, showing the change of frequency of the π mode of magnetron of FIG. 1.

With reference to FIG. 1, the basic features of a conventional magnetron, indicated generally by the reference numeral 1, are shown. However, the cathode of the magnetron 1 is not shown for clarity, this electrode would normally be located at the centre of the magnetron and would lie on the broken line shown in this drawing. The main basic features include an anode 2 having a plurality 3 of vanes, two of which 3a, 3b, are visible in this drawing. When viewed from above, the vanes are evenly spaced around the inner circumference of the cylindrical portion 4 of the anode 2, and extend inwardly from it, such that a plurality of resonant cavities are formed. The vanes 3a, 3b, are connected to alternate others of the vanes by means of straps 5a, 5b. Straps are used in order to increase the frequency separation of different modes of operation of the magnetron. In the desired π mode of operation, alternate anode vanes are at the same r.f. potential. Thus, if alternate vanes are connected together by straps, no additional inductance will be introduced because the ends of the straps are at the same potentials. The straps add capacitance to the circuit, and so the π mode frequency is altered. In modes other than the π mode, the voltage difference between alternate anode vanes is not zero, and so the straps introduce inductance as well as capacitance resulting in different frequency shifts than occur for the π mode. Thus, undesired modes are removed in frequency from the π mode. The magnetron 1 also comprises pole pieces 6a, 6b arranged to produce magnetic fields required for operation of the magnetron.

In accordance with the invention, the magnetron further comprises a dielectric resonator 7. The resonator 7 comprises an annulus, or washer, of ceramic material. The resonator 7 is located in a space in the magnetron between an end portion of the anode vanes 3 and one of the pole pieces 6a, such that it is in communication with the plurality of vanes, including the vanes 3a, 3b. The resonator is also shown in communication with one of the pole pieces 6a, but it need not be so. The invention has been found to work even when the pole piece is spaced from the resonator. The resonator contacts the anode vanes 3 at an end portion remote from the strapped end. It has been found by the inventor that the beneficial effects of the invention are greatly enhanced when the resonator is in communication with this end portion of the vanes as opposed to the strapped end portion.

The resonator 7 is arranged to absorb radiation generated in an unwanted mode of operation of the magnetron, such as the π-1 mode and thereby suppress transmission of power in this mode. The mechanism by which the resonator suppresses the π-1 mode is complex but a précis is given below.

The resonator, in the form of a ceramic washer, has a number of resonances which occur when the average perimeter of the washer equates to an integral number “n” of guide wavelengths. The electromagnetic resonances of the magnetron anode and the ceramic washer have a symmetry about the axes of the magnetron and the ceramic, with periodic variations of electric and magnetic field in azimuth. When two circuits share a common localised region of field, then there is coupling between the circuits, which can be represented by mutual induction in an equivalent circuit model. Where the common fields of the resonances all have azimuthal symmetry about the magnetron axis, it is evident that coupling only exists between resonances which have the same number of periods in azimuth, as well as commonality in position and resonant frequency. Otherwise, the coupling by the different regions will cancel due to symmetry. In the case of the ceramic washer located above the end of the anode, the common fields are the magnetic fields above the backs of the anode cavities. For the resonances of the ceramic, the magnetic fields vary sinusoidally in azimuth with “n” cycles, where “n” is the resonance number. For the anode resonances, the currents circulating round the backs of the cavities have the same periodicity as the voltages around the anode surface. At the ends of the anode, the axial magnetic field in each cavity divides over the end of the vanes to return down the next cavities, i.e. have the same periodicity in azimuth. Thus, the diameters of a ceramic washer of high dielectric constant can be chosen such that the n=1 resonance between the vane ends and the pole piece face can be made to coincide in frequency with the π-1 resonance of the anode. These two resonances are strongly coupled together by common azimuthal n=1 magnetic field at the outer diameter, so that the resistive losses in the ceramic resonance are transformed into a comparatively large series resistance in the π-1 resonance, giving a low Q. Since in the π mode there is no strap current other than local capacity currents, there is no zero mode component of the magnetic fields to couple to the n=0 ceramic resonance.

FIGS. 2, 3 and 4 chart experimental data Resonators of different internal diameter were made and various properties of the magnetron including these resonators, in different modes of operation, were monitored. For example, FIG. 2 charts the Q factor of the magnetron in two modes of operation. The Q factor varies with different internal diameters of dielectric washer. The upper line of FIG. 2 shows the Q factor of the π mode of operation—this is the wanted mode of operation. The lower line shows the Q factor of the n−1 mode of operation—this is the unwanted mode. The Q (or quality) factor of a resonant cavity is the ratio of energy stored to energy lost by dissipation. As is shown in FIG. 2, the Q of the wanted π mode is only slightly reduced by the presence of the ceramic washer, a matter of a few percent. However, the Q of the π-1 mode reduces when washers having smaller internal diameter are used. When the value of the internal diameter of the washer falls below 12.5 mm, the Q of the π-1 mode drops to barely detectable levels, meaning that the power produced by the magnetron in this mode is almost completely dissipated in the apparatus. The lower limit of the internal diameter of the ceramic washer is dictated by the size of the pole piece 6a. It has been proposed to make this pole piece narrower in order to accommodate washers of smaller internal diameter. It is hoped that this will further improve suppression of the π-1 mode.

FIGS. 3 and 4 illustrate the changes in frequencies of the π and π-1 modes in the apparatus of the invention. With reference to FIG. 3, the uppermost line plots the change in resonant frequency of the ceramic washer itself for different internal diameters. The resonant frequency tends to decrease with decreasing size of the internal diameter of the washer. The central line illustrates the resonant frequency of the apparatus of the π-1 mode in the absence of the ceramic washer. The lower line shows the frequency of the π-1 mode when ceramic washers of different internal diameters are present. Overall, the frequency is reduced with a ceramic washer and the effect is more pronounced with washers of smaller internal diameter. The resonant frequency varies from 10.75 GHz with a 13.3 mm internal diameter washer to approximately 10.45 GHz With the 11.3 mm internal diameter washer whereas, without a resonator, the resonant frequency is approximately 10.85 GHz.

With reference to FIG. 4, the frequency of the π mode without ceramic is shown by the upper line on the chart. The resonant frequency is just above 9.44 GHz. The presence of a ceramic causes the resonant frequency of the π mode to change by a few MHz—from 9.425 GHz with a 13.3 mm washer to 9.405 GHz with an 11.3 mm washer. This can be accommodated for by slight adjustments to the operating system of the magnetron, and is within the capabilities of the skilled person.

A suitable ceramic for the resonator is alumina. This may be loaded in order to make the material more lossy. The ceramic may be metallised on one or more surfaces. As ceramic washers may be manufactured cheaply in bulk, the inventor's solution to the problem of spurious radiation is both low-cost and simple. The cost of the resonator is typically a few pence, and the fitting of the resonator in the magnetron is uncomplicated, so that there is no appreciable increase in manufacturing and labour costs.

Although the invention was devised in relation to low power magnetrons, it is thought that it could readily apply to high power magnetrons. The invention has been discussed in relation to magnetrons having an anode strapped at one end region of the vanes, in which the effect of the resonator is most pronounced. The inventor has considered the application of the principles of the invention to anodes strapped at both end portions of the vanes. For this type of magnetron, it has been proposed to use a ceramic cylinder, a quarter (dielectric) wavelength along, of outside diameter the same as the backs of the cavities. Axial metallic strips or rods extend inside the cylinder for a length about a quarter dielectric wavelength from the ends of the vanes, being open at the far end. These form a coupled resonant circuit. This arrangement could be used at one or both ends of the anode. The strips could be metallised on the inner surface of the ceramic. This requires an axially deep end space, or a pole piece which extends inside the ceramic.

Further variations may be made without departing from the scope of the invention. For example, dielectric resonator need not be an annulus and need not be of a closed shape. Furthermore, the dielectric resonator need not contact all of the vanes.

1. A magnetron comprising an anode having at least one vane defining a plurality of cavities and a dielectric resonator in communication with the at least one vane arranged, in use, to at least partially absorb radiation generated in a predetermined mode of operation of the magnetron.

2. A magnetron comprising an anode having a plurality of vanes defining a plurality of cavities and a dielectric resonator in communication with at least one of the vanes arranged, in use, to at least partially absorb radiation generated in a predetermined mode of operation of the magnetron.

3. A magnetron as claimed in claim 1 or 2, in which the dimensions of the dielectric resonator are such that a predetermined resonance between a vane and a pole piece of the magnetron is substantially equal to the frequency of the predetermined mode.

4. A magnetron as claimed in any preceding claim, in which the predetermined mode is the π-1 mode.

5. A magnetron as claimed in any preceding claim, in which the dielectric resonator is of ceramics material.

6. A magnetron as claimed in claim 5, in which the ceramics material is alumina.

7. A magnetron as claimed in any preceding claim, in which the vanes are disposed about a common axis, the resonator is annular and is substantially co-axial with the vanes.

8. A magnetron, substantially as hereinbefore described, with reference to, or as illustrated in, the accompanying drawings.

9. A radar system incorporating a magnetron as claimed in any preceding claim.

10. Means for absorbing radiation generated by a magnetron in a predetermined mode of operation, said means comprising a dielectric resonator arranged to be in communication with at least one anode vane of the magnetron.

11. Radiation absorbing means as claimed in claim 10, in which the dielectric resonator is of ceramics material.

12. Radiation absorbing means as claimed in claim 11, in which the ceramics material is alumina.

13. Radiation absorbing means as claimed in claim 10, 11 or 12, in which the resonator is annular and is substantially co-axial with the vanes of the magnetron.

14. Means for absorbing radiation generated by a magnetron in a predetermined mode of operation, substantially as hereinbefore described, with reference to, or as illustrated in, the accompanying drawings.
